(19) United States
(12) Patent Application Publication
(10) Pub. No.: US 2008/0077470 A1
(43) Pub. Date: Mar. 27, 2008

(54) Respondent-information output apparatus, respondent-information output method, and computer product

(75) Inventor: Hideki Yamanaka, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/698,570

(22) Filed: Jan. 25, 2007

(30) Foreign Application Priority Data
Sep. 26, 2006 (JP) 2006-260972

(51) Int. Cl. G06F 17/30

(52) U.S. Cl. 705/10

(57) ABSTRACT

Log information indicative of a response operation performed by an agent belonging to a first line is stored in an agent state log, and a statistical-data accumulating unit calculates a total of handling time and a transfer probability included in the log information stored in the agent state log and stores the total of the accumulated handling time and transfer probability in a agent statistical data. An agent-state monitoring unit updates a transfer probability list in agent state data based on the total handling time and the transfer probability, and a routing engine unit estimates the number of agents to be needed in the future in a second line based on the transfer probability.

### BACKGROUND OF THE INVENTION

1. Field of the Invention

The present invention generally relates to an information output technology, and particularly relates to a technology for outputting respondent information about a respondent who responds to a query from a customer.

2. Description of the Related Art

It has become common for business enterprises to maintain contact centers (or call centers) for giving various services to the customers over a phone or a chat. Responding to queries or accepting service subscription applications from the customer are examples of such services.

In the contact center, agents are generally assigned to groups called “lines” based on a skill and an experience of each of the agents. When a call (or a chat message) is received at the contact center, the call is put through to a suitable agent based on the contents of the call.

Japanese Patent Application Laid-Open Nos. 2005-49976, 2003-6390, and H9-319812, for example, disclose conventional technologies for supporting the operation of the contact center.

FIG. 21 is a schematic for explaining a configuration of a typical contact center 10. As shown in FIG. 21, the agents are classified into three groups based on their skill levels. Specifically, each agent is assigned to any one of the group with the lowest level, i.e., a first line 11, the group with the second lowest level, i.e., a second line 12, and the group with the highest level, i.e., a final line 13.

The contact center 10 includes a PBX 20, various databases 30, and an automatic call distributor (ACD) 100. The PBX 20 receives a call from a customer and connects the received call to a phone (or a terminal) of the agent. The various databases 30 include a customer database (not shown) for managing customers and an incident database (not shown) for storing contents of past responses to customers.

The ACD 100 manages availability of a phone of each of the agents, and when the PBX 20 receives the call, selects an agent to be connected to a call. The ACD 100 is configured to first select a connection destination from among phones of the agents in the first line 11 when the PBX 20 receives a call from a customer.

The agent selected by the ACD 100 in the first line 11 responds to the customer by referring to the various databases 30. If the agent determines that the agent cannot handle the query because of its difficult contents or the like, the agent transfers the call to some other agent in the higher-level second line 12 or the highest-level final line 13 and hands over the response operation to the other agent.

Some queries from customers are urgent, so that it is necessary to promptly hand over those queries to the other agents with a view of improving customer satisfaction. Accordingly, it is required to put a proper number of the agents on standby at any time in the second line 12 and the final line 13 for potential responses to calls transferred from the first line 11.

However, the frequency of the occurrence of a call transfer varies depending on the contents of the query and the operation or on the level of the agent responding to the customer. Therefore, it is extremely difficult to determine the number of the agents to be put on standby in the lines after the first line.

If more than required agents are assigned as standby agents, a utilization (rate) of the agents with high skills decreases. Generally, a cost per agent who is highly skilled and richly experienced tends to be high. Therefore, if the utilization rate of the agents with high skills decreases, an entire cost effectiveness of the contact center 10 is deteriorated.

On the other hand, if less than required agents are assigned as standby agents and the call transfer frequently occurs, the customers need to wait until the agents with high skills become available. This disadvantageously makes the customers dissatisfied and uncomfortable, possibly causing degradation of the quality of services. Accordingly, there is a threat that the quality of the services degrades.

There is a need of a technology that can determine the appropriate number of standby agents in the lines behind the first line.

### SUMMARY OF THE INVENTION

It is an object of the present invention to at least partially solve the problems in the conventional technology.

According to an aspect of the present invention, a computer-readable recording medium that stores therein a computer program for outputting information on a plurality of first respondents who belong to a first respondent group and on a plurality of second respondents who belong to a second respondent group, the first respondents performing a first response operation for responding to a customer, the second respondents performing a second response operation for responding to the customer by taking over the first response operation, the computer program causing a computer to execute collecting log information about the first response operation performed by each of the first respondents, generating expected information about a third respondent to be needed in future in the second respondent group as the second respondent based on the log information, and outputting the expected information.

According to another aspect of the present invention, a method of outputting information on a plurality of first respondents who belong to a first respondent group and on a plurality of second respondents who belong to a second respondent group, the first respondents performing a first response operation for responding to a customer, the second respondents performing a second response operation for responding to the customer by taking over the first response operation, the method includes collecting log information about the first response operation performed by each of the first respondents, generating expected information about a third respondent to be needed in future in the second respondent group as the second respondent based on the log information, and outputting the expected information.

According to still another aspect of the present invention, a respondent-information output apparatus that outputs information on a plurality of first respondents who belong to a first respondent group and on a plurality of second respondents who belong to a second respondent group, the first respondents performing a first response operation for responding to a customer, the second respondents performing a second response operation for responding to the customer by taking over the first response operation, the respondent-information output apparatus includes a storing unit that stores therein log information about the first response operation performed by each of the first respondents, a generating unit that generates expected information about a third respondent to be needed in future in the second respondent group as the second respondent based on the log information stored in the storing unit, and an outputting unit that outputs the first expected information generated by the generating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an automatic call distributor (ACD) according to an embodiment of the present invention;

FIG. 2 is an example of the contents of call queue data shown in FIG. 1;

FIG. 3 is an example of the contents of an agent state log shown in FIG. 1;

FIG. 4 is a schematic for explaining a phase and a state of an agent according to the embodiment;

FIG. 5 is an example of the contents of agent statistical data shown in FIG. 1;

FIG. 6 is an example of the contents of agent state data shown in FIG. 1;

FIG. 7 is a graph of an example of the distribution of response-to-customer handling time according to the embodiment;

FIG. 8 is a schematic of a lognormal distribution and a confidence interval according to the embodiment;

FIG. 9 is a schematic of a normal distribution and a confidence interval corresponding to the lognormal distribution shown in FIG. 8;

FIG. 10 is a schematic for explaining transition of a transfer probability according to the embodiment;

FIG. 11 is a schematic for explaining expected return time according to the embodiment;

FIGS. 12A and 12B are schematics for explaining assignment of a transfer-target agent according to the embodiment;

FIG. 13 is a flowchart of a process procedure performed by a call-queue managing unit shown in FIG. 1;

FIG. 14 is a flowchart of a process procedure performed by an agent-state monitoring unit shown in FIG. 1;

FIG. 15 is a flowchart of a transfer-probability update processing shown in FIG. 14;

FIG. 16 is a flowchart of an expected-return-time update processing shown in FIG. 14;

FIG. 17 is a flowchart of a process procedure performed by a routing engine unit shown in FIG. 1;

FIG. 18 is a graph for explaining a regression analysis according to the embodiment;

FIG. 19 is an example of the contents of agent statistical data when the regression analysis shown in FIG. 18 is used;

FIG. 20 is a functional block diagram of a configuration of a computer that executes a respondent-information output program according to the embodiment; and

FIG. 21 is a schematic for explaining a configuration of a typical contact center.

### DETAILED DESCRIPTION OF THE PREFERRED EMBODIMENTS

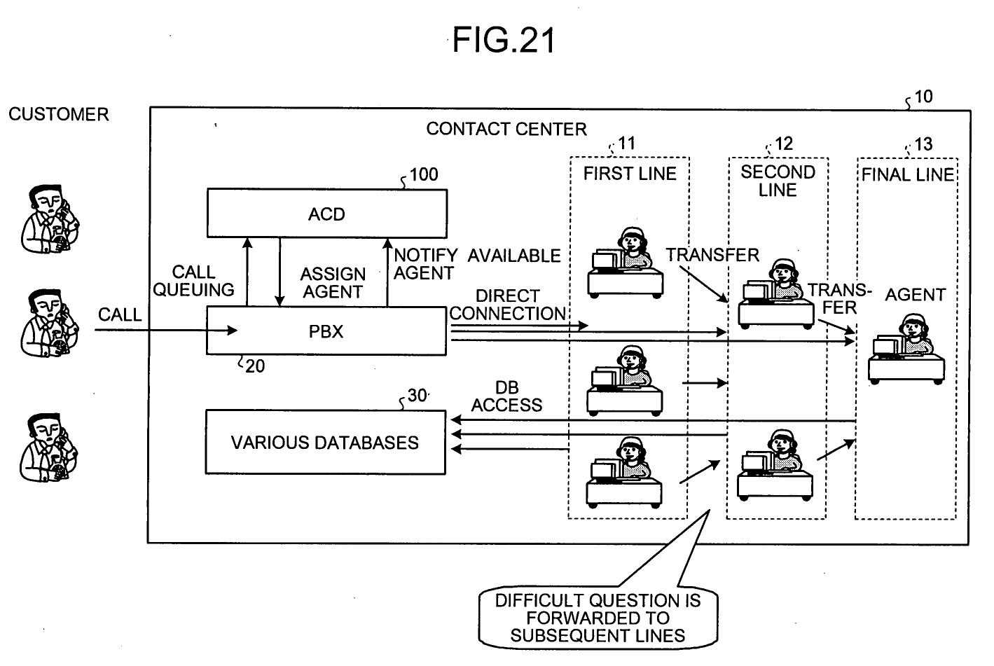

Exemplary embodiments of the present invention are explained below in detail with reference to the accompanying drawings. In the following embodiments, the present invention is applied to the automatic call distributor (ACD) 100 in the contact center 10 shown in FIG. 21 for the sake of explanation.

The ACD 100 estimates the number of agents required in the future in a line after the first line 11 and a time when those agents are going to be required, based on log information related to response operations that have been performed by agents belonging to the first line 11. Accordingly, the number of the agents to be on standby in a line after the first line 11 can properly be determined.

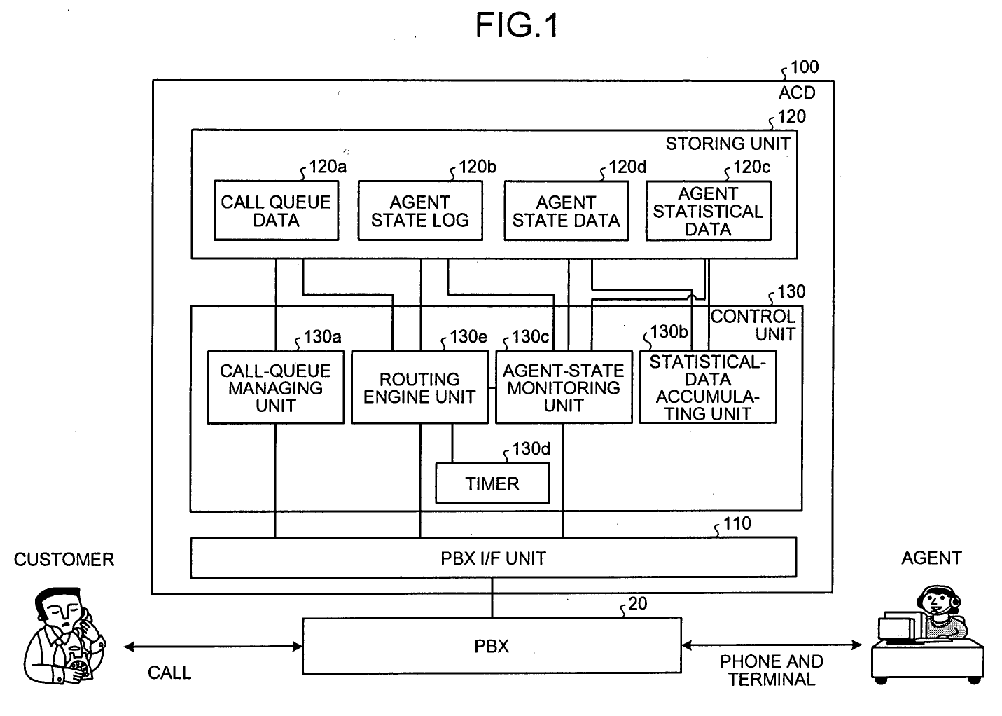

FIG. 1 is a functional block diagram of the ACD 100. The ACD 100 is connected to the PBX 20 that receives a call made by a customer on the phone and connects the received call to a phone of an agent. The ACD 100 includes a PBX interface (I/F) unit 110, a storing unit 120, and a control unit 130.

The PBX I/F unit 110 controls a communication of information held with the PBX 2.0. For example, the PBX I/F unit 110 receives information related to a call from the PBX 20 and transmits information related to the call and an assignment of the agent to the PBX 20.

The storing unit 120 stores therein various information. The storing unit 120 stores therein, for example, call queue data 120a, an agent state log 120b, agent statistical data 120c, and agent state data 120d.

The amount of data in the agent state log 120b and the agent state data 120d increases depending on the number of the agents and the number of the customers to be responded. Therefore, instead of storing in the storing unit 120, the agent state log 120b and the agent state data 120d can be stored in a database provided in the other device communicably connected to the ACD 100.

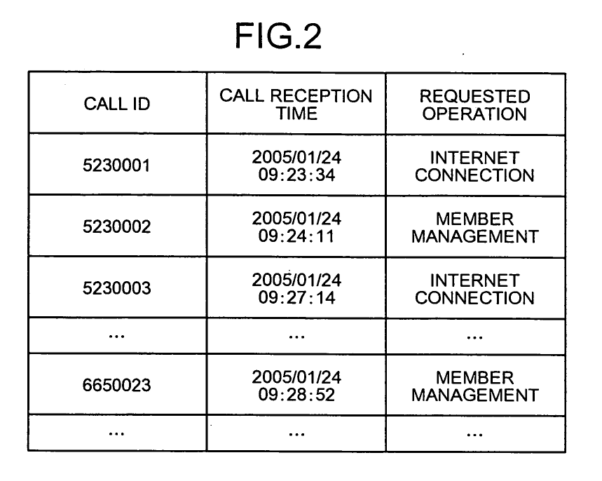

The call queue data 120a is data in which information related to calls transmitted from phones of customers are stored in order of reception time. FIG. 2 is an example of the contents of the call queue data 120a in a tabular form. In the call queue data 120a, information such as “call ID” that uniquely identifies a call, “call reception time” that indicates a time when the call is received, and “requested operation” that indicates an operation requested from the customer are associating with one another for every call are stored in order of the call reception time. New information is added to the call queue data 120a whenever information related to a call is transmitted from the PBX 20.

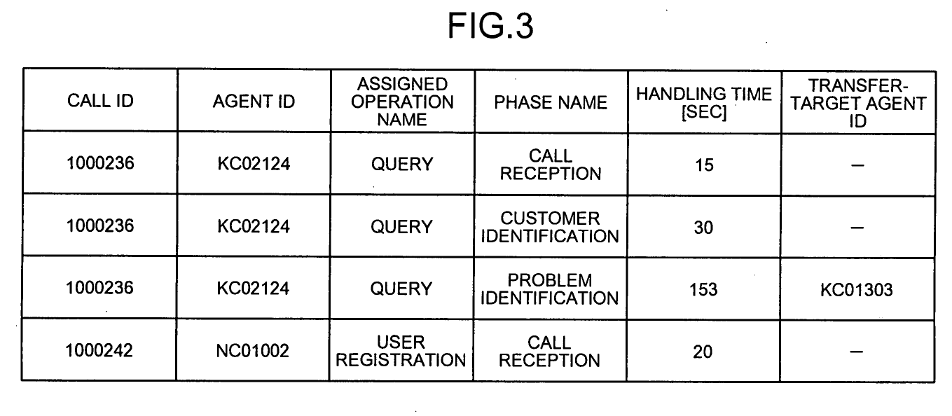

The agent state log 120b is a log of an operation assigned to each agent and a phase of the operation. FIG. 3 is an example of the contents of the agent state log 120b in a tabular form. In the agent state log 120b, such information is specifically recorded that is structured with “call ID” that identifies a call, “agent ID” that identifies an agent, “assigned operation name” that indicates an operation assigned to the agent, “phase name” that indicates a phase (process) in which the agent proceeds with the operation, “handling time” that indicates a time spent for a customer-response processing in the phase, and “transfer-target agent ID” that indicates a transfer-target agent to whom the agent transfers the call. New information is added to the agent state log 120b for each agent who responds to a customer whenever the operation and the phase assigned to each of the agents are changed.

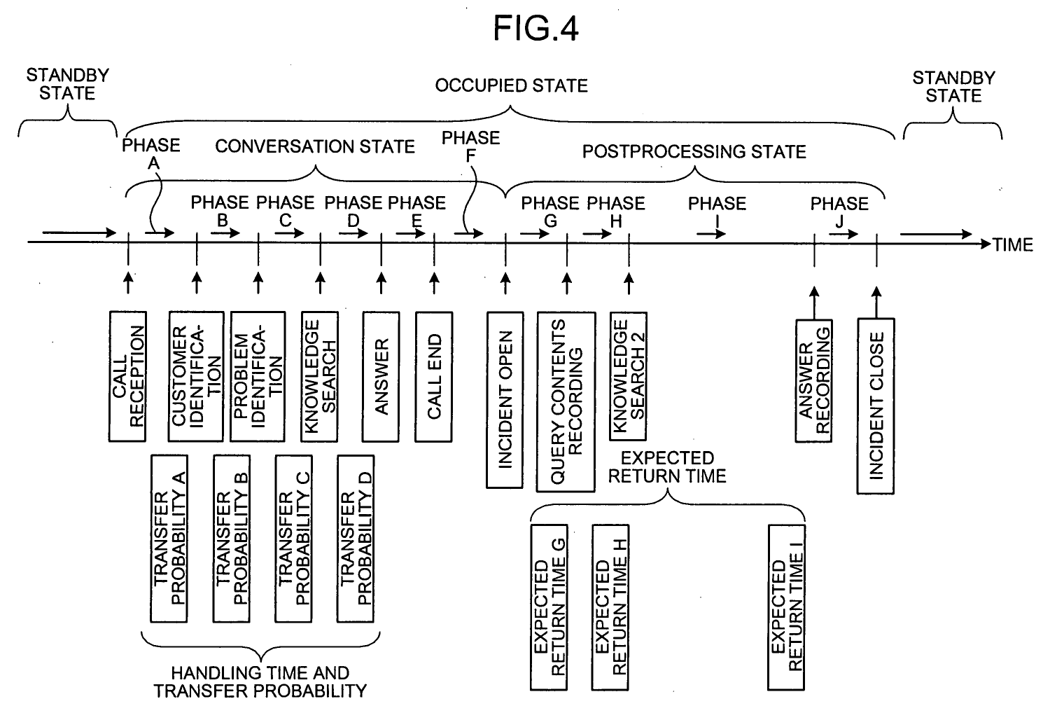

FIG. 4 is a schematic for explaining the phase and the state of an agent. As shown in FIG. 4, the state of an agent can be typically divided into a standby state, in which the agent is free to accept a call, and an occupied state in which the agent is busy responding to a customer. Further, the occupied state is divided into a conversation state and a postprocessing state. A plurality of the phases is defined in each of the conversation state and the postprocessing state.

Six phases from phases A to F are defined in the conversation state. The phase A is a “call reception” phase that is initiated when a call from a customer is connected to a phone (or a terminal) of the agent. The phase B is a “customer identification” phase that is initiated when the customer is identified by the agent. The phase C is a “problem identification” phase that is initiated when the contents of the operation (such as query or service subscription) requested from the customer is confirmed by the agent. The phase D is a “knowledge search” phase that is initiated when the agent searches the various databases 30 for responding to the customer for the contents of the operation requested from the customer. The phase E is an “answer” phase that is initiated when the agent answers to the customer. The phase F is a “call end” phase that is initiated when the agent ends the connection to the phone of the customer.

Four phases from phases G to J are defined in the postprocessing state. The phase G is an “incident open” phase that is initiated when the agent instructs start of recording the contents of the response to the customer in the various databases 30. The phase H is a “query contents recording” phase that is initiated when the contents of the response is actually recorded in the various databases 30 by the agent. The phase I is a “knowledge search 2” phase that is initiated when the agent searches the various databases 30 for confirming detailed information related to the contents of the response to record the contents of the response. The phase J is an “answer recording” phase that is initiated when the agent completes recording the contents of an answer. The phase J is terminated when the agent performs an operation (“incident close” shown in FIG. 4) for ending the recording operation in the various databases 30.

In this manner, each of the phases is initiated and/or terminated when the agent performs a certain operation. When one phase is switched to another, an agent's terminal automatically notifies the ACD 100 of an operation change or a phase change via the PBX 20. The notice includes information corresponding to the agent such as the agent ID, the belonging line, the agent's state, the call ID of the responded call, the operation name, the phase name, and the handling time as well as the transfer-target agent ID if the agent has transferred the call to the other agent.

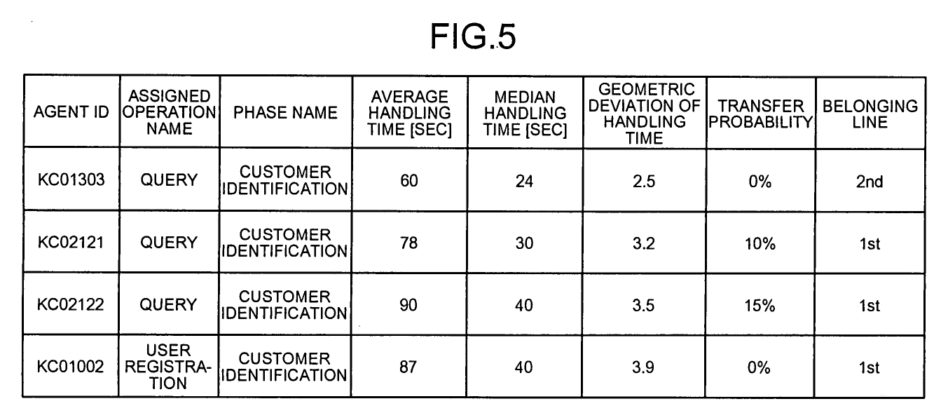

Referring back to the explanation of the storing unit 120, the agent statistical data 120c is data in which the handling time is accumulated with respect to each agent, operation, or phase based on the information recorded in the agent state log 120b. FIG. 5 is an example of the contents of the agent statistical data 120c in tabular form. In the agent statistical data 120c, information structured as follows is stored with respect to each agent, operation, or phase. The information is structured to include “agent ID”, “assigned operation name”, “phase name”, “average handling time”, “median handling time”, “geometric deviation of handling time”, “transfer probability”, and “belonging line”. Specifically, the “agent ID” identifies the agent, the “assigned operation name” indicates the operation, and the “phase name” indicates the phase. The “average handling time” indicates an average of the handling time for processing the operation by the agent. The “median handling time” indicates a median obtained by approximating the distribution of transfer probabilities (probabilities of call transfer) relative to the handling time to the lognormal distribution. The “geometric deviation of handling time” indicates the geometric deviation of the lognormal distribution of the handling time. The “belonging line” indicates a line to which the agent belongs. The information is updated at predetermined time intervals. The lognormal distribution, methods for calculating the average handling time, the median handling time, and the geometric deviation of handling time will be explained later in detail.

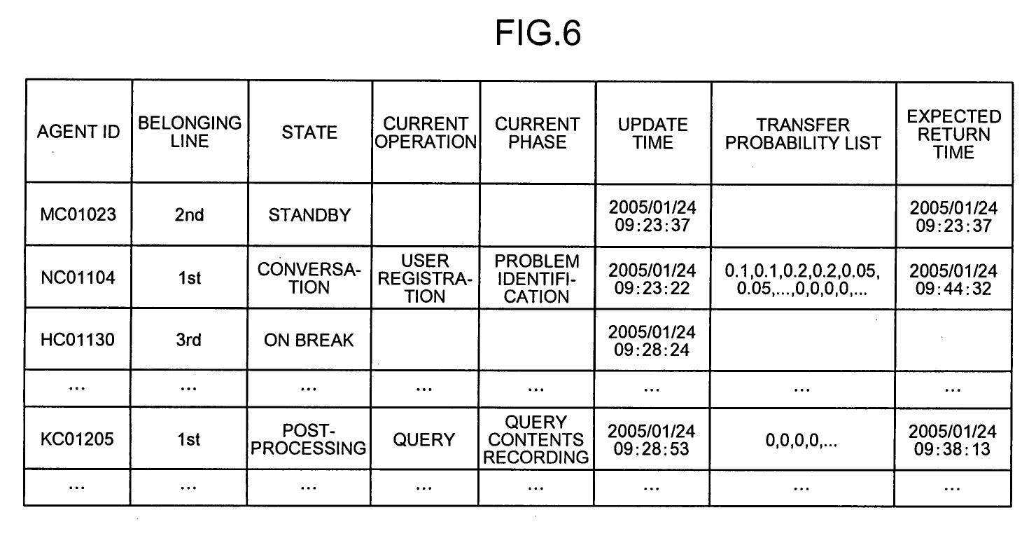

The agent state data 120d represents operation states of all the agents. FIG. 6 is an example of the contents of the agent state data 120d in a tabular form. In the agent state data 120d, information structured as follows is stored with respect to each agent. The information is structured to include “agent ID”, “belonging line”, “state”, “current operation”, “current phase”, “update time”, “transfer probability list”, and “expected return time”. The “state” indicates the current operation state of the agent, and the “current operation” indicates the operation in which the agent is currently involved. The “current phase” indicates a phase of the operation with which the agent is currently involved. The “update time” indicates a time when the information is previously updated. The “transfer probability list” temporally lists transfer probabilities of subsequent phases to the current phase of the operation with which the agent is currently involved with respect to each predetermined unit time. The “expected return time” indicates an expected time when the agent finishes the response of the current operation and returns to be in the standby state. The information is updated whenever the operation assigned to each of the agents or the phase of the operation is changed for all the agents who respond to customers. The method of generating the transfer probability list and that of calculating the expected return time will be explained later in detail.

The control unit 130 controls the ACD 100 and includes a call-queue managing unit 130a, a statistical-data accumulating unit 130b, a agent-state monitoring unit 130c, a timer 130d, and a routing engine unit 130e.

The call-queue managing unit 130a adds information related to a call received from the PBX 20 to the call queue data 120a. More specifically, when receiving the information related to the call from the PBX 20, the call-queue managing unit 130a determines a call ID to the call and sets a requested operation, which is an operation requested from the customer, based on information acquired from a telephone number or an interactive voice response (IVR) included in the information related to the call. Thereafter, the call-queue managing unit 130a adds the call ID, the requested operation, and the reception time of the call to the call queue data 120a (see FIG. 2).

The statistical-data accumulating unit 130b is a processing unit that accumulates the handling time with respect to each agent, operation, or phase based on the information recorded in the agent state log 120b at predetermined time intervals, such as once a month, and that updates the agent statistical data 120c based on a result of the accumulation. How the statistical-data accumulating unit 130b accumulates the handling time is explained below in detail.

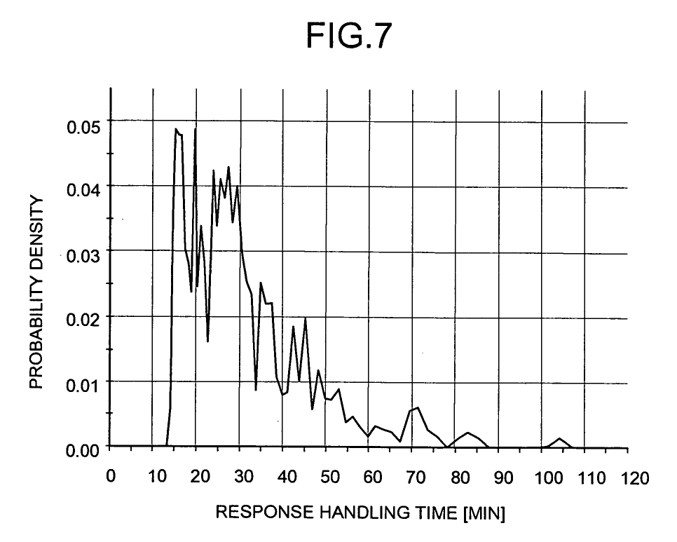

At start of the predetermined time interval, the statistical-data accumulating unit 130b sequentially reads out the information from the agent state log 120b, and obtains the distribution of transfer probabilities relative to the response-to-customer handling time with respect to each agent, operation, or phase. FIG. 7 is an exemplary graph of the distribution of the response-to-customer handling time of an agent. The horizontal axis represents the response handling time spent in minutes for the customer response while the vertical axis represents a probability density, i.e., the transfer probability.

Thereafter, the statistical-data accumulating unit 130b obtains the lognormal distribution that approximates to the obtained distribution of the transfer probabilities. More specifically, the statistical-data accumulating unit 130b defines the lognormal distribution represented by a median m (which is 50% in a confidence interval for 0 to m according to the definition of the median) and a geometric deviation γ. The statistical-data accumulating unit 130b changes the median m and the geometric deviation γ as required to obtain the lognormal distribution that approximates to the distribution of the transfer probabilities.

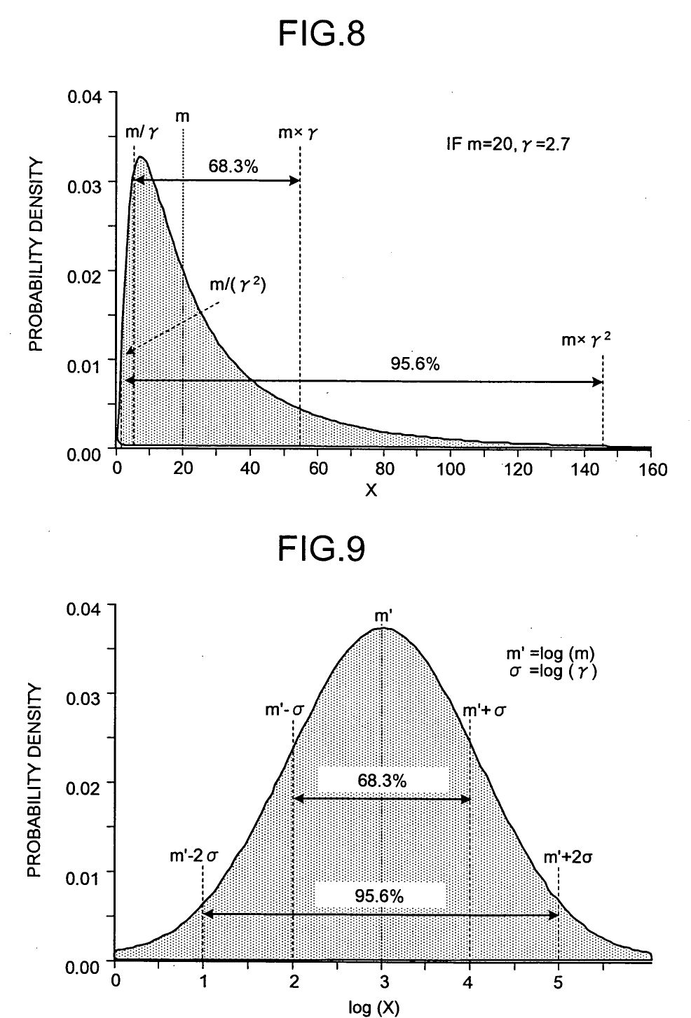

FIG. 8 is a schematic of the lognormal distribution and the confidence interval. The lognormal distribution in FIG. 8 approximates to the distribution shown in FIG. 7. In the graph shown in FIG. 8, X on the horizontal axis represents the response handling time while the vertical axis represents a probability density, i.e., the transfer probability. FIG. 9 is a schematic of a normal distribution and the confidence interval corresponding to the lognormal distribution shown in FIG. 8. In other words, the horizontal axis in FIG. 9 represents the log of X, i.e., log(X), which is shown in FIG. 7.

The statistical-data accumulating unit 130b calculates an average of the handling time for each agent, operation, or phase based on the median m and the geometric deviation γ from the lognormal distribution. The average is calculated by using the following equation:

Average=m×exp(log(γ)²/2) (1)

The statistical-data accumulating unit 130b also calculates the transfer probability for each agent, operation, or phase. The transfer probability is calculated by using the following equation if data on the identical agent, operation, or phase is used as target data:

Transfer probability=(the number of data for which the transfer-target agent ID is set among the target data)/(the number of target data) (2)

The statistical-data accumulating unit 130b updates the information stored in the agent statistical data 120c with respect to each agent, operation, or phase, based on the average of the handling time, the median m and the geometric deviation γ in the lognormal distribution, and the transfer probability.

The agent-state monitoring unit 130c updates the information in the agent state data 120d and outputs the information to the agent state log 120b, based on the operation state of the agent. Specifically, upon receiving a notice of the state change or a phase change from the agent's terminal when the operation currently assigned to each of the agents and the phase of the operation changes, the agent-state monitoring unit 130c acquires the agent ID, the belonging line, the state, the operation name, and the phase name from the notice. Thereafter, the agent-state monitoring unit 130c generates the transfer probability list and calculates the expected return time. The method of generating the transfer probability list and that of calculating the expected return time is explained below in detail.

The method of generating the transfer probability list is explained first. Upon receiving the notice of the state change or the phase change, the agent-state monitoring unit 130c searches the agent statistical data 120c based on the agent ID and the operation name included in the notice, and retrieves the average handling time and the transfer probability with respect to each phase corresponding to the agent ID and the operation name.

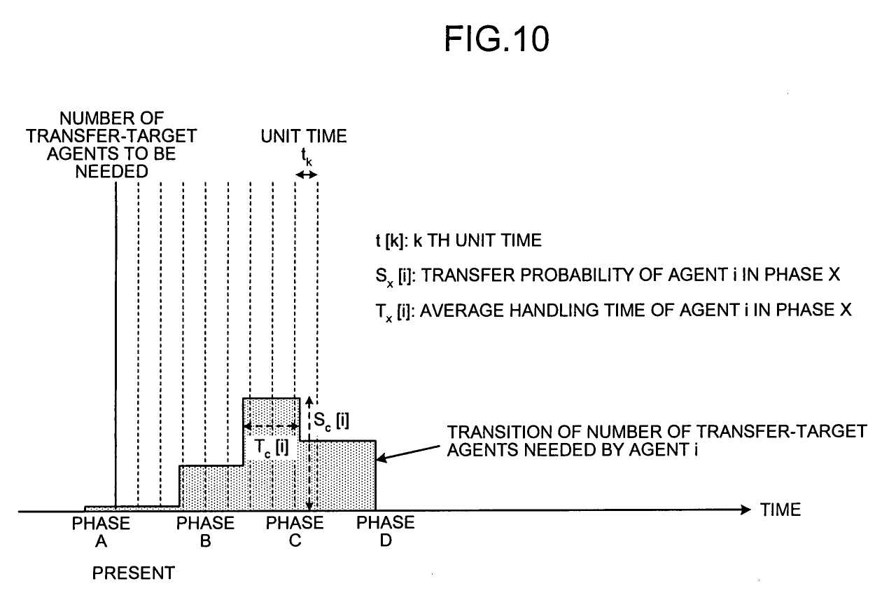

The agent-state monitoring unit 130c temporally aligns the acquired average handling time and the transfer probabilities in order of the phase and estimates the transition of the transfer probability in the subsequent phases to the current phase. FIG. 10 is a schematic of the transition of the transfer probability. The transition of the transfer probability shown in FIG. 10 also represents the number of the transfer-target agents needed by the agent at each of time points. For example, if the transfer probability is 0.1 (10%), the number of the needed transfer-target agents is 0.1.

After estimating the transition of the transfer probability, the agent-state monitoring unit 130c divides the transition of the transfer probability in the subsequent phases to the current phase with respect to each unit time, and temporally aligns the divided transfer probabilities to generate the transfer probability list. For example, if the average handling time is 5 seconds and the transfer probability is 0 (0%) in the phase A, the average handling time is 10 seconds and the transfer probability is 0.01 (1%) in the phase B, the average handling time is 15 seconds and the transfer probability is 0.2 (20%) in the phase C, and the average handling time is 10 seconds and the transfer probability is 0.02 (2%) in the phase D with, assuming that the unit time is 5 seconds, the generated transfer probability list is “0, 0.01, 0.01, 0.2, 0.2, 0.2, 0.02, 0.02”.

The method of generating the calculating the expected return time will next be explained. Upon receiving the notice of the state change or the phase change, the agent-state monitoring unit 130c searches the agent statistical data 120c based on the agent ID and the operation name included in the notice and retrieves the median handling time and the geometric deviation of handling time with respect to each phase corresponding to the agent ID and the operation name.

The agent-state monitoring unit 130c calculates a value by multiplying the remaining time in the current phase by the geometric deviation of handling time of the current phase for each phase, using the acquired median handling time and the geometric deviation of handling time. Furthermore, the agent-state monitoring unit 130c calculates a value by multiplying the median handling time by the geometric deviation of handling time with respect to each phase, for each of the subsequent phases to the current phase. Thereafter, the agent-state monitoring unit 130c obtains a total value of all the calculated values and adds the total value to the current time to calculate an expected time (expected return time) at which the agent finishes the current response operation and returns into the standby state.

Referring to FIG. 8, the probability (confidence interval) that each of the actual phases is terminated within the value (time) obtained by the multiplication for each phase is 84.15% (=50%+68.3%/2). The probability can be changed simply by changing the geometric deviation (including positive real numbers) to be multiplied by the median to a new value corresponding to the probability.

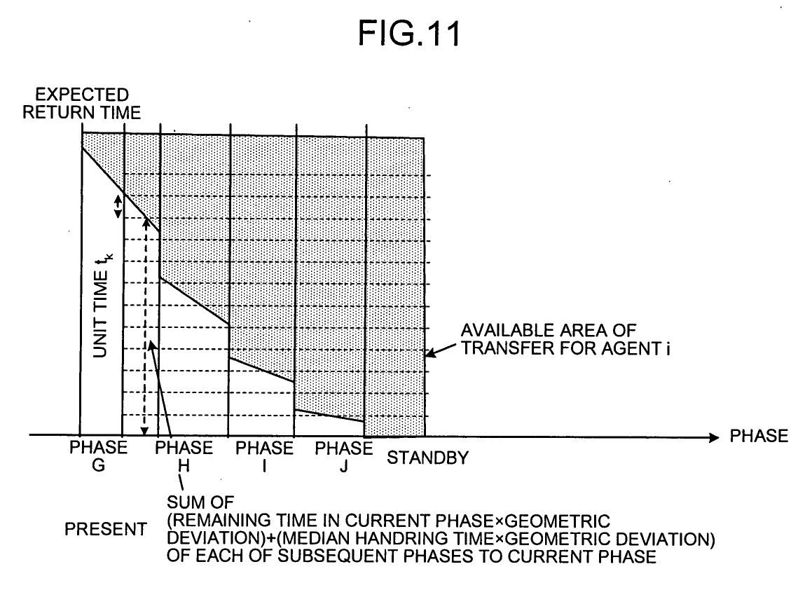

FIG. 11 is a schematic for explaining the expected return time. In the example shown in FIG. 11, the expected return time is calculated as follows. A value obtained by multiplying the remaining time by the geometric deviation of handling time of the phase G, a value obtained by multiplying the median handling time by the geometric deviation of handling time of the phase H, a value obtained by multiplying the median handling time by the geometric deviation of handling time of the phase I, and a value obtained by multiplying the median handling time of the phase J by the geometric deviation of handling time of the phase J are added to each other, and the total is added to the current time.

In this manner, the agent-state monitoring unit 130c acquires the necessary information from the received notice, generates the transfer probability list, and calculates the expected return time. Thereafter, the agent-state monitoring unit 130c updates the information related to the agent stored in the agent state data 120d based on these pieces of information.

The agent-state monitoring unit 130c acquires the call ID, the agent ID, the operation name, the phase name, the handling time, and the transfer-target agent ID from the notice, and outputs the information to the agent state log 120b.

When the routing engine unit 130e assigns a call to the agent, it sends a notice of call assignment to the agent-state monitoring unit 130c. Upon receiving the notice of call assignment, the agent-state monitoring unit 130c similarly acquires the agent ID, the belonging line, the state, the operation name, and the phase name from the notice and updates the information related to the agent stored in the agent state data 120d. Moreover, the agent-state monitoring unit 130c acquires the call ID, the agent ID, the operation name, the phase name, the handling time, and the transfer-target agent ID from the notice, and outputs the acquired information to the agent state log 120b.

The timer 130d transmits a clock signal to the routing engine unit 130e at predetermined time intervals.

The routing engine unit 130e estimates the number of the transfer-target agents needed in the subsequent phases to the current phase and the number of the available agents based on the agent state data 120d, calculates the number of the agents actually to be put on standby, and determines the agents to be put on standby and the agents to be assigned to answer calls.

Specifically, upon receiving the clock signal from the timer 130d, the routing engine unit 130e refers to the agent state data 120d, acquires the transfer probability list of each agent, and calculates a total of the acquired transfer probability lists. In this manner, the routing engine unit 130e generates an expected transition list that indicates the number of the transfer-target agents to be required by the agents answering calls.

The routing engine unit 130e refers to the agent state data 120d to acquire the expected return time with respect to each agent. The routing engine unit 130e then generates a transition list of the number of the transfer-target agents (number of available agents) to be provided with respect to each unit time, based on the acquired expected return time.

The routing engine unit 130e subtracts the number of the needed transfer-target agents from the number of the available agents with respect to each unit time based on the generated two lists. Furthermore, the routing engine unit 130e determines the minimum of the difference as the number of the transfer-target agents currently ready to be assigned.

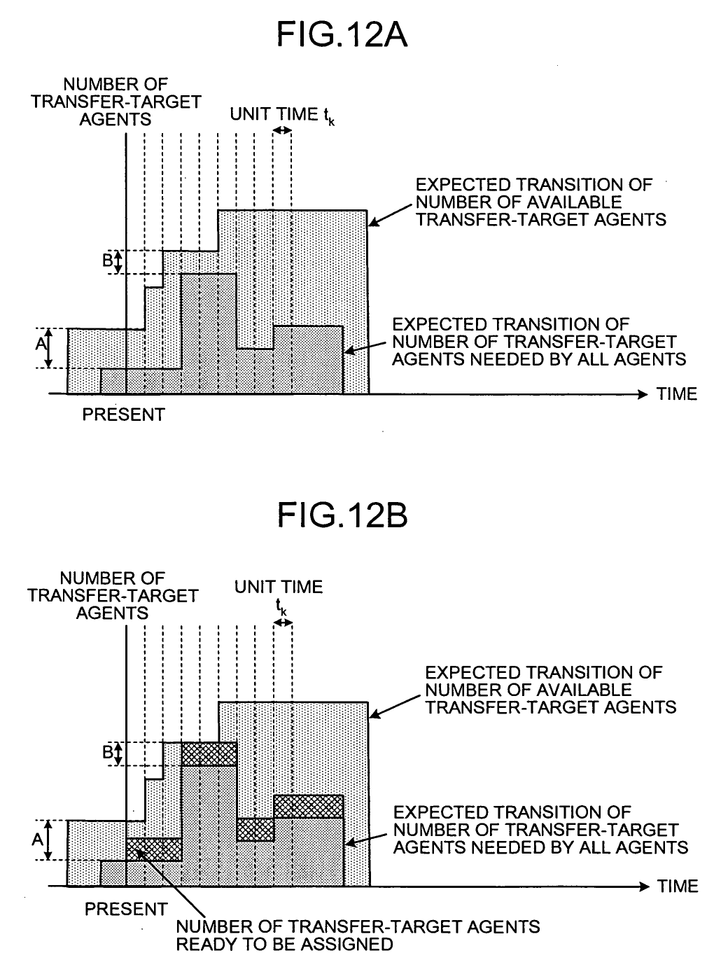

FIGS. 12A and 12B are schematics for explaining assignment of the transfer-target agents. In the example shown in FIG. 12A, the difference between the number of the currently available transfer-target agents and the number of the needed transfer-target agents is A at a current time point while the minimum of the difference calculated with respect to each unit time is B. Therefore, as shown in FIG. 12B, the number of the transfer-target agents currently ready to be assigned is determined as B for the following reasons. If the transfer-target agents are assigned at the current point by as much as A, the number of the needed transfer-target agents exceeds the number of the available transfer-target agents when the difference is estimated as B before the assignment. As a result, it is difficult to transfer the customer call at this current point.

In this manner, after determining the number of the transfer-target agents currently ready to be assigned, the routing engine unit 130e subtracts the number of the transfer-target agents currently ready to be assigned from the number of the currently available transfer-target agents. The routing engine unit 130e thus calculates the number of the agents needed to be put on standby.

The routing engine unit 130e refers to the agent state data 120d, sequentially selects agents with shorter idle time from among those in the second line 12, and sets the selected agents as the standby agents. Accordingly, the operation time can be balanced among the agents.

The routing engine unit 130e selects agents with longer idle time from among the rest of the agents in the second line 12, and notifies the PBX 20 to subsequently assign the calls stored in the call queue data 120a to the selected agents in order. Further, the routing engine unit 130e transmits the notice of the call assignment including the information related to the agents who have been assigned to the calls to the agent-state monitoring unit 130c. Therefore, it is possible to equally assign the response operation to each of the agents.

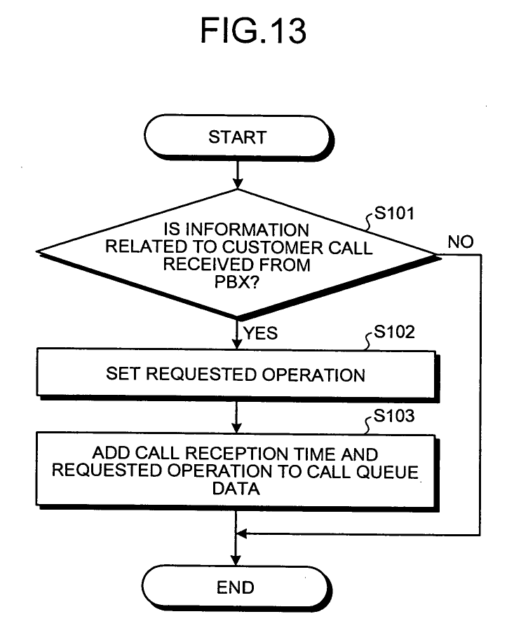

FIG. 13 is a flowchart of a process procedure performed by the call-queue managing unit 130a. The call-queue managing unit 130a receives the information related to the customer call (Yes at step S101), sets the requested operation based on the received information (step S102), and adds the call reception time and the requested operation to the call queue data 120a (step S103).

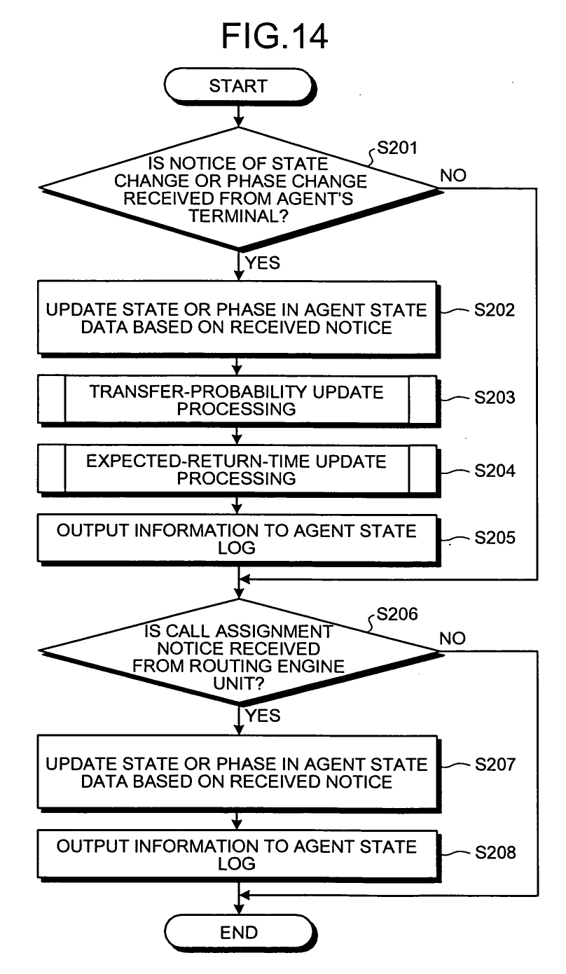

FIG. 14 is a flowchart of a process procedure performed by the agent-state monitoring unit 130c. Upon receiving the notice of the state change or the phase change from the agent's terminal (Yes at step S201), the agent-state monitoring unit 130c updates the state or the phase in the agent state data 120d based on the notice (step S202). Moreover, the agent-state monitoring unit 130c performs a transfer-probability update processing (step S203) and an expected-return-time update processing (step S204). If the agent-state monitoring unit 130c does not receive the notice of the state change or the phase change from the agent's terminal (No at step S201), the system control proceeds to step S206. The transfer-probability update processing and the expected-return-time update processing will be explained later in detail.

The agent-state monitoring unit 130c outputs information to the agent state log 120b based on the received notice (step S205).

Upon receiving the notice of the call assignment from the routing engine unit 130e (Yes at step S206), the agent-state monitoring unit 130c updates the state or the phase in the agent state data 120d based on the received notice (step S207). Moreover, the agent-state monitoring unit 130c outputs the information to the agent state log 120b based on the received notice (step S208). If the agent-state monitoring unit 130c does not receive the notice of the call assignment from the routing engine unit 130e (No at step S206), the agent-state monitoring unit 130c terminates the process.

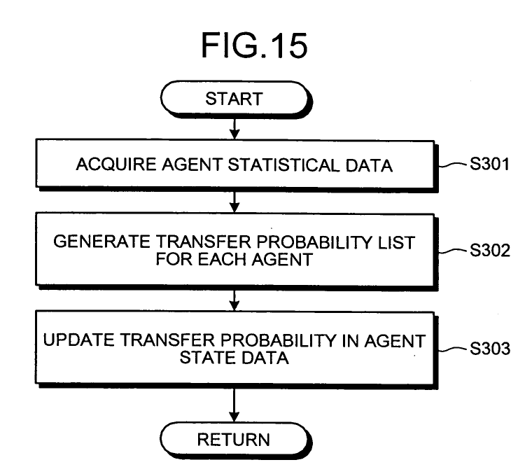

FIG. 15 is a flowchart of the transfer-probability update processing shown in FIG. 14. In the transfer-probability update processing, the agent-state monitoring unit 130c acquires information from the agent statistical data 120c (step S301), and generates the transfer probability list for each agent (step S302). Subsequently, the agent-state monitoring unit 130c updates the transfer probability list in the agent state data 120d based on the generated transfer probability list (step S303).

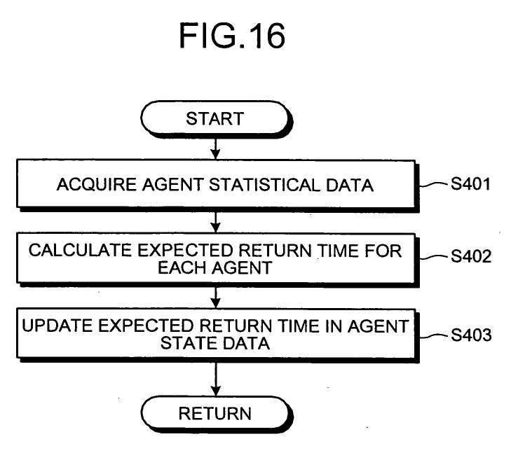

FIG. 16 is a flowchart of the expected-return-time update processing shown in FIG. 14. In the expected-return-time update processing, the agent-state monitoring unit 130c acquires information from the agent statistical data 120c (step S401), and calculates the expected return time for each agent (step S402). Subsequently, the agent-state monitoring unit 130c updates the expected return time in the agent state data 120d based on the calculated expected return time (step S403).

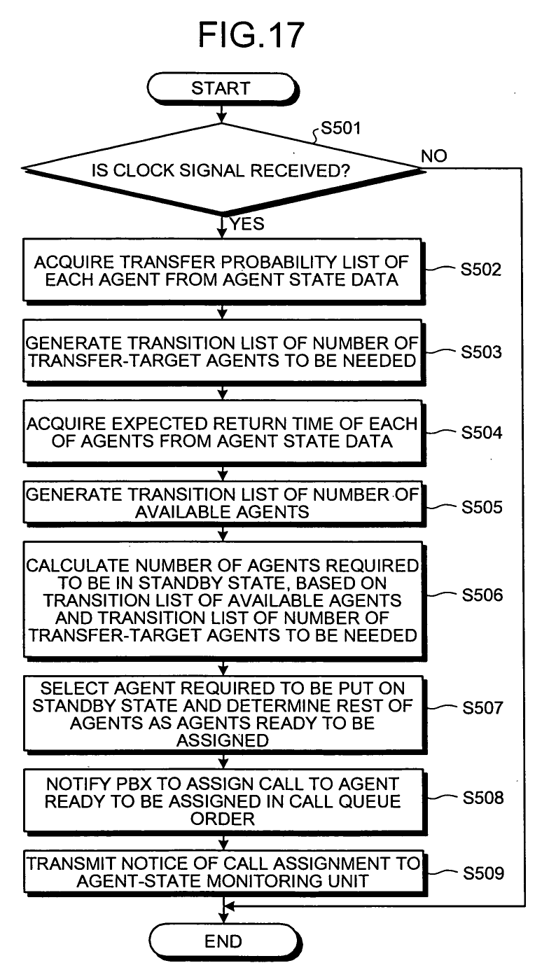

FIG. 17 is a flowchart of a process procedure performed by the routing engine unit 130e. Upon receiving the clock signal form the timer 130d (Yes at step S501), the routing engine unit 130e acquires the transfer probability list of each agent from the agent state data 120d (step S502). Moreover, the routing engine unit 130e generates the transition list of the number of transfer-target agents to be needed (step S503). If the routing engine unit 130e does not receive the clock signal form the timer 130d (No at step S501), the routing engine unit 130e terminates the process.

The routing engine unit 130e acquires the expected return time of each agent from the agent state data 120d (step S504), and generates the transition list of the number of the available agents (step S505).

The routing engine unit 130e calculates the number of the agents required to be in the standby state based on the generated transition list of the available agents and the transition list of the needed transfer-target agents (step S506). The routing engine unit 130e selects the agents to be put on standby from among those in the second line in the agent state data 120d, and determines the rest of the agents as the agents ready to be assigned (step S507).

The routing engine unit 130e notifies the PBX 20 to sequentially assign the calls stored in the call queue data 120a to the agents ready to be assigned (step S508). Moreover, the routing engine unit 130e transmits the notice of the call assignment related to the agents assigned to the calls to the agent-state monitoring unit 130c (step S509).

As described above, the log information related to the response operation that has been performed by the agent belonging to the first line 11 is stored in the agent state log 120b. The statistical-data accumulating unit 130b calculates a total of the handling time and the transfer probabilities included in the log information stored in the agent state log 120b, and stores the total in the agent statistical data 120c. The agent-state monitoring unit 130c updates the transfer probability list in the agent state data 120d based on the handling time and the transfer probability. The routing engine unit 130e estimates the number of the agents to be needed in the future in the second line 12 based on the transfer probability list. Therefore, it is possible to accurately determine the number of the agents to be in the standby state in the second line 12.

Furthermore, the statistical-data accumulating unit 130b calculates a total of the handling time included in the log information stored in the agent state log 120b, and stores the total handling time in the agent statistical data 120c. The agent-state monitoring unit 130c updates the expected return time in the agent state data 120d based on the total handling time. The routing engine unit 130e estimates the number of the agents available in the future and the time when the agents of the available numbers are to be assigned. Therefore, it is possible to accurately determine the number of the agents to be in the standby state in the second line 12, with a consideration of the maximum number of the available agents.

Moreover, the information stored in the agent state data 120d includes the transfer probability list and the expected return time generated from the respondent number and the time. Therefore, it is possible to accurately determine the number of the agents to be in the standby state in the second line 12, with a relative consideration of the number of the respondents to be needed and the numbers of the respondents available in the future to each other.

It is explained above that the agent-state monitoring unit 130c uses the average handling time in the agent statistical data 120c to generate the transfer probability list and to calculate the expected return time. Alternatively, the agent-state monitoring unit 130c can dynamically estimate the handling time necessary for the subsequent phases to the current phase by performing a regression analysis on the information in the agent state log 120b to define a regression model equation that represents the relation of the handling time between the phases, and by assigning the handling time included in the received notice to a variable of the regression model equation. Processing procedures performed by the statistical-data accumulating unit 130b when the regression analysis is used will be explained below.

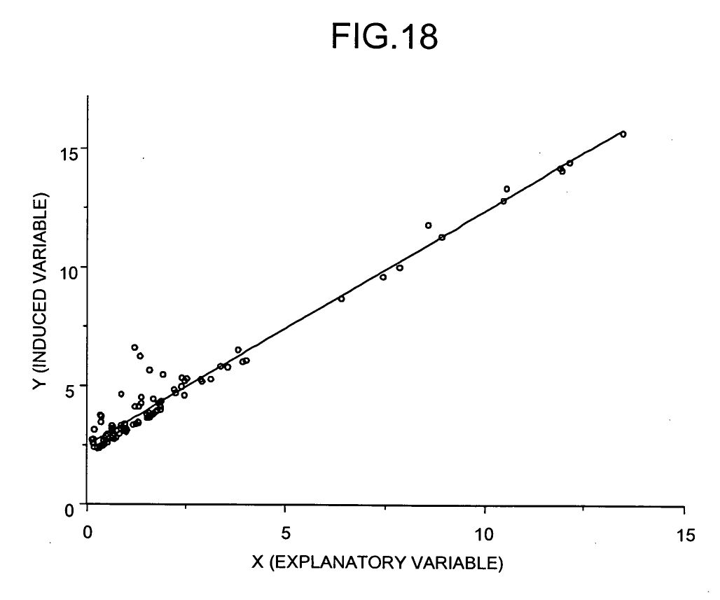

FIG. 18 is a graph for explaining the regression analysis. The horizontal axis (explanatory variable) represents the handling time of the operation X whereas the vertical axis (induced variable) represents the handling time of an operation Y. The statistical-data accumulating unit 130b plots values of the handling time for the information in the agent state log 120b, and calculates variables a and b that satisfy Y=aX+b.

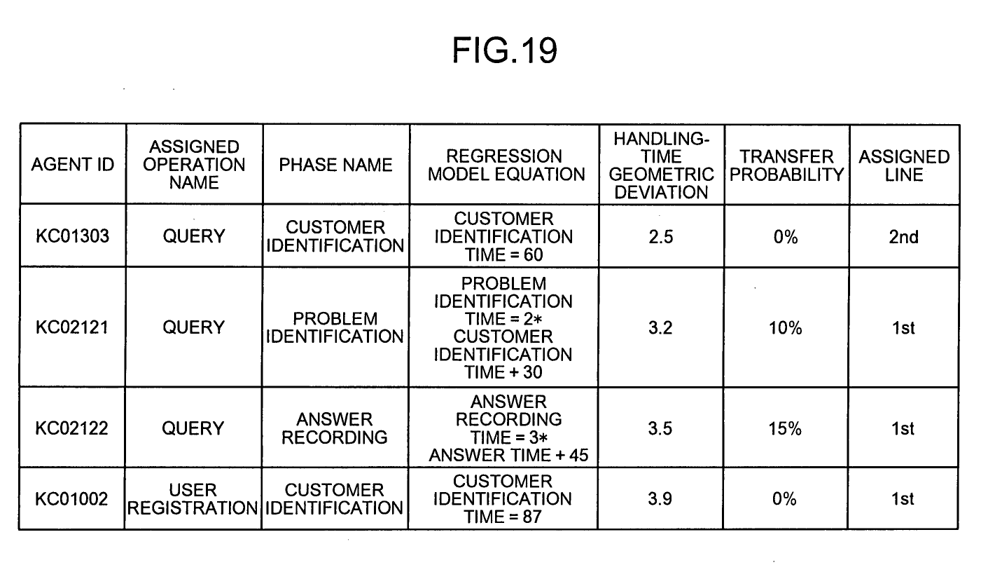

Accordingly, such a regression model equation as (customer identification time)=60, (problem identification time)=2×(customer identification time)+30, or (answer recording time)=3×(answer time)+45 is obtained. FIG. 19 is an example of the contents of the agent statistical data 120c when the regression analysis is used. The statistical-data accumulating unit 130b updates the agent statistical data 120c as shown in FIG. 19 after obtaining the regression model equation.

As can be understood, if the handling time is to be calculated by performing the regression analysis, it is possible to calculate the handling time in the subsequent phases to a current phase by using the handling time in the current phase immediately after end of the current phase. Therefore, it is possible to generate the transfer probability and calculate the expected return time using accurate handling time as compared to such a case of using the average handling time.

The ACD 100 has been explained above as hardware; however, it is possible to realize the ACD 100 as software. When realizing the ACD 100 as software, a respondent-information output program is executed on a computer to implement the functions of the ACD 100 on the computer. The computer that executes the respondent-information output program will be explained below.

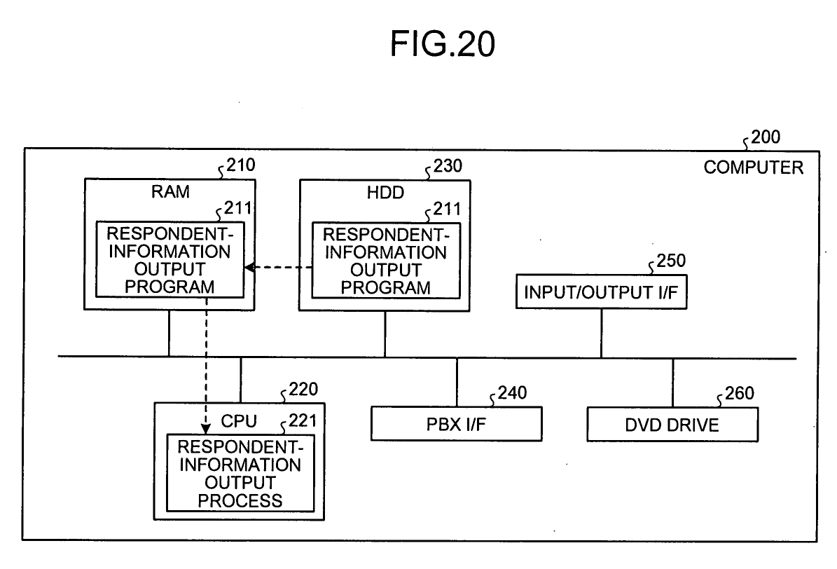

FIG. 20 is a functional block diagram of a computer 200 that executes the respondent-information output program. The computer 200 includes a random access memory (RAM) 210, a central processing unit (CPU) 220, a hard disk drive (HDD) 230, a PBX I/F 240, an input/output I/F 250, and a digital versatile disk (DVD) drive 260.

The RAM 210 is a memory that stores therein a computer program and a midway result of executing the computer program. The CPU 220 is a central processing unit that reads the computer program from the RAM 210 and executes the computer program.

The HDD 230 is a disk device that stores therein various computer programs and the data. The PBX I/F 240 is an interface for connecting the computer 200 to the PBX 20.

The input/output I/F 250 is an interface for connecting an input device, such as a mouse or a keyboard, to a display device. The DVD drive 260 is a device for reading and writing data from and to the DVD.

A respondent-information output program 211 to be executed on the computer 200 is stored in the DVD, read out from the DVD by the DVD drive 260, and installed into the computer 200.

The installed respondent-information output program 211 is stored in the HDD 230, read out by the RAM 210, and executed as a respondent-information output process 221 by the CPU 220.

Of the various types of processings explained herein, it is acceptable to manually perform a part or all of the processings that have been explained to be performed automatically. Conversely, it is acceptable to automatically perform, using a well-known technique, a part or all of the processings that have been explained to be performed manually.

The constituent elements of the apparatuses shown in the drawings are based on functional concepts. The constituent elements do not necessarily have to be physically arranged in the way shown in the drawings. In other words, the specific modes in which the apparatuses are distributed and integrated are not limited to those shown in the drawings. A part or all of the apparatuses can be distributed or integrated functionally or physically in any desired units, according to various loads and the status of use.

A part or all of the processing functions offered by the apparatuses can be realized by a CPU and a program analyzed and executed by the CPU, or can be realized as hardware with wired logic.

According to an aspect of the present invention, it is possible to accurately determine the number of agents to be put on standby in each line.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for outputting information on a plurality of first respondents who belong to a first respondent group and on a plurality of second respondents who belong to a second respondent group, the first respondents performing a first response operation for responding to a customer, the second respondents performing a second response operation for responding to the customer by taking over the first response operation, the computer program causing a computer to execute:
collecting log information about the first response operation performed by each of the first respondents;
generating expected information about a third respondent to be needed in future in the second respondent group as the second respondent based on the log information; and
outputting the expected information.

2. The computer-readable recording medium according to claim 1, wherein the expected information includes information about a fourth respondent available in the future as the second respondent based on the log information.

3. The computer-readable recording medium according to claim 1, wherein the expected information includes the number of the third respondents and time when the third respondents are expected to be needed.

4. The computer-readable recording medium according to claim 2, wherein the expected information includes the number of the fourth respondents and time when the fourth respondents are expected to be available.

5. The computer-readable recording medium according to claim 1, wherein the generating includes performing a regression analysis using the log information, and generating the expected information based on the result of the regression analysis.

6. The computer-readable recording medium according to claim 1, the computer program further causes the computer to execute:
determining the number of fifth respondents from among the second respondents to be put on standby at the current time point based on the log information; and
first selecting the second respondents with shorter idle time as the fifth respondent by as much as the number determined at the determining.

7. The computer-readable recording medium according to claim 5, the computer program further causes the computer to execute:
second selecting the second respondents having longer idle time and that were not selected at the first selecting as sixth respondents; and
assigning the sixth respondents as the first respondents.

8. A method of outputting information on a plurality of first respondents who belong to a first respondent group and on a plurality of second respondents who belong to a second respondent group, the first respondents performing a first response operation for responding to a customer, the second respondents performing a second response operation for responding to the customer by taking over the first response operation, the method comprising:
collecting log information about the first response operation performed by each of the first respondents;
generating expected information about a third respondent to be needed in future in the second respondent group as the second respondent based on the log information; and
outputting the expected information.

9. The method according to claim 8, wherein the expected information includes information about a fourth respondent available in the future as the second respondent based on the log information.

10. The method according to claim 8, wherein the expected information includes the number of the third respondents and time when the third respondents are expected to be needed.

11. The method according to claim 8, wherein the generating includes performing a regression analysis using the log information, and generating the expected information based on the result of the regression analysis.

12. The method according to claim 8, further comprising:
determining the number of fifth respondents from among the second respondents to be put on standby at the current time point based on the log information; and
first selecting the second respondents with shorter idle time as the fifth respondent by as much as the number determined at the determining.

13. The method according to claim 12, further comprising:
second selecting the second respondents having longer idle time and that were not selected at the first selecting as sixth respondents; and
assigning the sixth respondents as the first respondents.

14. A respondent-information output apparatus that outputs information on a plurality of first respondents who belong to a first respondent group and on a plurality of second respondents who belong to a second respondent group, the first respondents performing a first response operation for responding to a customer, the second respondents performing a second response operation for responding to the customer by taking over the first response operation, the respondent-information output apparatus comprising:
a storing unit that stores therein log information about the first response operation performed by each of the first respondents;
a generating unit that generates expected information about a third respondent to be needed in future in the second respondent group as the second respondent based on the log information stored in the storing unit; and
an outputting unit that outputs the first expected information generated by the generating unit.

15. The respondent-information output apparatus according to claim 14, wherein the expected information includes information about a fourth respondent available in the future as the second respondent based on the log information in the storing unit.

16. The respondent-information output apparatus according to claim 14, wherein the expected information includes the number of the third respondents and time when the third respondents are expected to be needed.

17. The respondent-information output apparatus according to claim 15, wherein the expected information includes the number of the fourth respondents and time when the fourth respondents are expected to be available.

18. The respondent-information output apparatus according to claim 14, wherein the generating unit performs a regression analysis using the log information in the storing unit, and generates the expected information based on the result of the regression analysis.

19. The respondent-information output apparatus according to claim 14, further comprising:
a determining unit that determines the number of fifth respondents from among the second respondents to be put on standby at the current time point based on the log information; and
a first selecting unit that selects the second respondents with shorter idle time as the fifth respondent by as much as the number determined at the determining.

20. The respondent-information output apparatus according to claim 19, further comprising:
a second selecting unit that selects the second respondents having longer idle time and that were not selected at the first selecting as sixth respondents; and
an assigning unit that assigns the sixth respondents as the first respondents.
